(19) United States
(12) Patent Application Publication
(10) Pub. No.: US 2005/0158026 A1
(43) Pub. Date: Jul. 21, 2005

(54) Method and apparatus for reproducing scalable video streams

(75) Inventors: Sung-chol Shin, Suwon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/037,048

(22) Filed: Jan. 19, 2005

(30) Foreign Application Priority Data
Jan. 19, 2004 (KR) 10-2004-0003985

(51) Int. Cl. H04N 5/783

(52) U.S. Cl. 386/68; 386/111

(57) ABSTRACT

A method and apparatus for reproducing scalable video streams are provided. In the method and apparatus, multimedia data provided by video streaming service is searched fast using a characteristic that a video stream having temporal scalability is flexible to temporal levels. The apparatus includes a playback speed setting unit setting a playback speed when the playback speed is selected for a bitstream, a control unit determining a temporal level corresponding to the playback speed set by the playback speed setting unit and extracting frames to be decoded from the bitstream according to the determined temporal level, and a timing synchronization unit synchronizing the frames that are decoded with a frame rate of an original video signal using a timing signal.

### CROSS-REFERENCE TO RELATED APPLICATION

This application claims priority from Korean Patent Application No. 10-2004-0003985 filed on Jan. 19, 2004 in the Korean Intellectual Property Office, the disclosure of which is incorporated herein by reference in its entirety.

### BACKGROUND OF THE INVENTION

1. Field of the Invention

The present invention relates to a method and apparatus for reproducing scalable video streams, and more particularly, to a video reproducing method and apparatus in which video streams having temporal scalability due to scalable video coding can be quickly searched.

2. Description of the Related Art

With the development of information communication technology including the Internet, video communication as well as text and voice communication has explosively increased.

Conventional text communication cannot satisfy users' various demands, and thus multimedia services that can provide various types of information such as text, pictures, and music have increased.

Multimedia data requires a large capacity of storage media and a wide bandwidth for transmission since the amount of multimedia data is usually large in relative terms to other types of data. Accordingly, a compression coding method is requisite for transmitting multimedia data including text, video, and audio. For example, a 24-bit true color image having a resolution of 640*480 needs a capacity of 640*480*24 bits, i.e., data of about 7.37 Mbits, per frame.

When an image such as this is transmitted at a speed of 30 frames per second, a bandwidth of 221 Mbits/sec is required. When a 90-minute movie based on such an image is stored, a storage space of about 1200 Gbits is required.

Accordingly, a compression coding method is a requisite for transmitting multimedia data including text, video, and audio.

In such a compression coding method, a basic principle of data compression lies in removing data redundancy.

Data redundancy is typically defined as: (i) spatial redundancy in which the same color or object is repeated in an image; (ii) temporal redundancy in which there is little change between adjacent frames in a moving image or the same sound is repeated in audio; or (iii) mental visual redundancy taking into account human eyesight and perception dull to high frequency.

Data can be compressed by removing such data redundancy. Data compression can largely be classified into lossy/lossless compression, according to whether source data is lost, intraframe/interframe compression, according to whether individual frames are compressed independently, and symmetric/asymmetric compression, according to whether time required for compression is the same as time required for recovery.

In addition, data compression is defined as real-time compression when a compression/recovery time delay does not exceed 50 ms and as scalable compression when frames have different resolutions.

As examples, for text or medical data, lossless compression is usually used. For multimedia data, lossy compression is usually used.

Meanwhile, intraframe compression is usually used to remove spatial redundancy, and interframe compression is usually used to remove temporal redundancy.

Transmission performance is different depending on transmission media.

Currently used transmission media have various transmission rates. For example, an ultrahigh-speed communication network can transmit data of several tens of megabits per second while a mobile communication network has a transmission rate of 384 kilobits per second.

In related art video coding methods such as Motion Picture Experts Group (MPEG)-1, MPEG-2, H.263, and H.264, temporal redundancy is removed by motion compensation based on motion estimation and compensation, and spatial redundancy is removed by transform coding.

These methods have satisfactory compression rates, but they do not have the flexibility of a truly scalable bitstream since they use a reflexive approach in a main algorithm.

Accordingly, to support transmission media having various speeds or to transmit multimedia at a data rate suitable to a transmission environment, data coding methods having scalability, such as wavelet video coding and subband video coding, may be suitable to a multimedia environment. Scalability indicates the ability to partially decode a single compressed bitstream, that is, the ability to perform a variety of types of video reproduction.

Scalability includes spatial scalability indicating a video resolution, Signal to Noise Ratio (SNR) scalability indicating a video quality level, temporal scalability indicating a frame rate, and a combination thereof.

Among many techniques used for wavelet-based scalable video coding, motion compensated temporal filtering (MCTF) that was introduced by Ohm and improved by Choi and Wood is an essential technique for removing temporal redundancy and for video coding having flexible temporal scalability. In MCTF, coding is performed on a group of pictures (GOPs) and a pair of a current frame and a reference frame are temporally filtered in a motion direction, which will be described with reference to FIG. 1A.

FIG. 1A schematically illustrates temporal decomposition during scalable video coding and decoding using MCTF.

In FIG. 1A, an L frame is a low frequency frame corresponding to an average of frames while an H frame is a high frequency frame corresponding to a difference between frames.

As shown in FIG. 1A, in a coding process, pairs of frames at a low temporal level are temporally filtered and then decomposed into pairs of L frames and H frames at a higher temporal level, and the pairs of L frames are again temporally filtered and decomposed into frames at a higher temporal level. An encoder performs wavelet transformation on one L frame at the highest temporal level and the H frames and generates a bitstream. Frames indicated by shading in the drawing are ones that are subjected to a wavelet transform.

More specifically, the encoder encodes frames from a low temporal level to a high temporal level.

Meanwhile, a decoder performs an inverse operation to the encoder on the frames indicated by shading and obtained by inverse wavelet transformation from a high level to a low level for reconstruction.

That is, L and H frames at temporal level 3 are used to reconstruct two L frames at temporal level 2, and the two L frames and two H frames at temporal level 2 are used to reconstruct four L frames at temporal level 1.

Finally, the four L frames and four H frames at temporal level 1 are used to reconstruct eight frames.

Such MCTF-based video coding has an advantage of improved flexible temporal scalability but has disadvantages such as unidirectional motion estimation and bad performance in a low temporal rate.

Many approaches have been researched and developed to overcome these disadvantages. One of them is unconstrained MCTF (UMCTF) proposed by Turaga and Mihaela, which will be described with reference to FIG. 1B.

FIG. 1B schematically illustrates temporal decomposition during scalable video coding and decoding using UMCTF.

UMCTF allows a plurality of reference frames and bi-directional filtering to be used and thereby provides a more generic framework.

In addition, in a UMCTF scheme, nondichotomous temporal filtering is feasible by appropriately inserting an unfiltered frame, i.e., an A-frame.

UMCTF uses A-frames instead of filtered L-frames, thereby remarkably increasing the quality of pictures at a low temporal level.

As described above, since both of MCTF and UMCTF provide flexible temporal scalability for video coding, a decoder can completely decode some frames without decoding all frames according to a temporal level.

In other words, when temporal levels are controlled according to the performance of a video streaming application during decoding, video streaming service can be reliably provided.

Users of a streaming service usually desire to freely use diverse multimedia. However, related art video streaming service only adjusts the picture quality of encoded multimedia data to a user's environment and does not meet the user's desire to freely adjust a multimedia data playback speed.

Moreover, there are no known, sufficient studies on a method of changing a playback speed in the field of MCTF and UMCTF schemes using temporal scalability flexible to temporal levels. Accordingly, a method of changing a playback speed in video decoding supporting temporal scalability is desired.

### SUMMARY OF THE INVENTION

The present invention provides a method and apparatus for fast searching multimedia data provided by a video streaming service using a characteristic that a video stream having temporal scalability is flexible to temporal levels.

According to one aspect of the present invention, there is provided a method of reproducing scalable video streams, including determining a temporal level corresponding to a playback speed requested for a bitstream; extracting frames to be decoded from all frames in the bitstream according to the determined temporal level; and decoding the extracted frames.

In addition, the control unit generates the timing signal used for synchronizing the frames that are decoded with the frame rate of the original video signal to allow the timing synchronization unit to set the timing signal so that a fast video search can be performed.

In the present invention, the bitstream has temporal scalability due to scalable video coding, and the playback speed is a speed at which images of frames in the bitstream are displayed for a fast search of moving videos.

Meanwhile, the playback speed has directionality. In an exemplary embodiment, the playback speed is one of a reverse playback speed and a forward playback speed according to a playback direction.

### BRIEF DESCRIPTION OF THE DRAWINGS

The above and other features and advantages of the present invention will become more apparent by describing in detail exemplary embodiments thereof with reference to the attached drawings in which:

FIG. 1A schematically illustrates temporal decomposition during scalable video coding and decoding using motion compensated temporal filtering (MCTF);

FIG. 1B schematically illustrates temporal decomposition during scalable video coding and decoding using unconstrained motion compensated temporal filtering (UMCTF);

FIG. 2 is a schematic diagram of an encoder according to an embodiment of the present invention;

FIG. 3 illustrates an example of a procedure in which a spatial transform unit shown in FIG. 2 decomposes an input image or frame into sub-bands using wavelet transform;

FIG. 4 is a schematic diagram of a decoder according to an embodiment of the present invention;

FIG. 5 is a schematic diagram of a video stream reproducing apparatus using the decoder shown in FIG. 4, according to an embodiment of the present invention;

FIG. 6 is a schematic flowchart of a method of reproducing video streams according to an embodiment of the present invention;

FIG. 7 illustrates encoding and decoding procedures to explain a method of reproducing video streams according to another embodiment of the present invention; and

FIGS. 8A through 8C illustrate a procedure for reproducing video streams using MCTF in an embodiment of the present invention.

### DETAILED DESCRIPTION OF THE INVENTION

Hereinafter, in describing the structure and operations of an apparatus for reproducing scalable video streams according to the present invention, a scalable video encoder performing video coding supporting temporal scalability will be described first, and then a decoder decoding a bitstream received from the encoder and an apparatus for reproducing scalable video streams that controls the decoder to decode only a part of the bitstream received from the encoder according to a temporal level in an embodiment of the present invention will be sequentially described.

In addition, hereinafter, in embodiments of the present invention, a method of reproducing scalable video streams is implemented using a motion compensated temporal filtering (MCTF)-based or unconstrained MCTF (UMCTF)-based video coding method supporting temporal scalability. Of course, the embodiments herein should be considered just exemplary embodiments of the present invention. It will be understood by those skilled in the art that various changes may be made therein to implement a module of changing a playback speed by controlling a temporal level according to a playback speed requested by a user and decoding a part of a scalable video stream encoded using a video coding method supporting temporal scalability other than the MCTF-based and UMCTF-based video coding methods and that other equivalent embodiments within the spirit of the invention may be envisioned.

Further, in embodiments of the present invention, a playback speed is changed using a timing control method of generating and setting a timing signal to synchronize each of decoded frames with a frame rate of an original video signal. However, it will be understood by those skilled in the art that various changes may be made therein to implement a module of reproducing decoded frames at a playback speed requested by a user using methods of controlling clock time of each decoded frame and the like other than the timing control method and that other equivalent embodiments within the spirit of the invention may be envisioned.

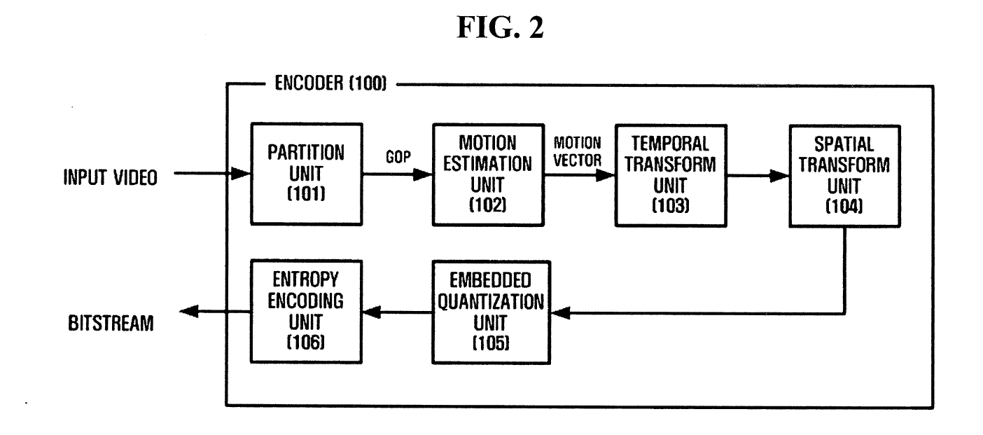

FIG. 2 is a schematic diagram of an encoder 100 according to an embodiment of the present invention.

The encoder 100 includes a partition unit 101, a motion estimation unit 102, a temporal transform unit 103, a spatial transform unit 104, an embedded quantization unit 105, and an entropy encoding unit 106.

The partition unit 101 divides an input video into basic encoding units, i.e., groups of pictures (GOPs).

The motion estimation unit 102 performs motion estimation with respect to frames included in each GOP, thereby obtaining a motion vector.

A hierarchical method such as a Hierarchical Variable Size Block Matching (HVSBM) may be used to implement the motion estimation.

The temporal transform unit 103 decomposes frames into low- and high-frequency frames in a temporal direction using the motion vector obtained by the motion estimation unit 102, thereby reducing temporal redundancy.

For example, an average of frames may be defined as a low-frequency component, and half of a difference between two frames may be defined as a high-frequency component. Frames are decomposed in units of GOPs. Frames may be decomposed into high and low frequency frames by comparing pixels at the same positions in two frames without using a motion vector. However, the method not using a motion vector is less effective in reducing temporal redundancy than the method using a motion vector.

In other words, when a portion of a first frame is moved in a second frame, an amount of a motion can be represented by a motion vector. The portion of the first frame is compared with a portion to which a portion of the second frame at the same position as the portion of the first frame is moved by the motion vector, that is, a temporal motion is compensated. Thereafter, the first and second frames are decomposed into low and high frequency frames.

Motion Compensated Temporal Filtering (MCTF) or Unconstrained Motion Compensated Temporal Filtering (UMCTF), for example, may be used for temporal filtering.

In currently known wavelet transform techniques, a frame is decomposed into low and high frequency sub-bands and wavelet coefficients of the respective frames are obtained.

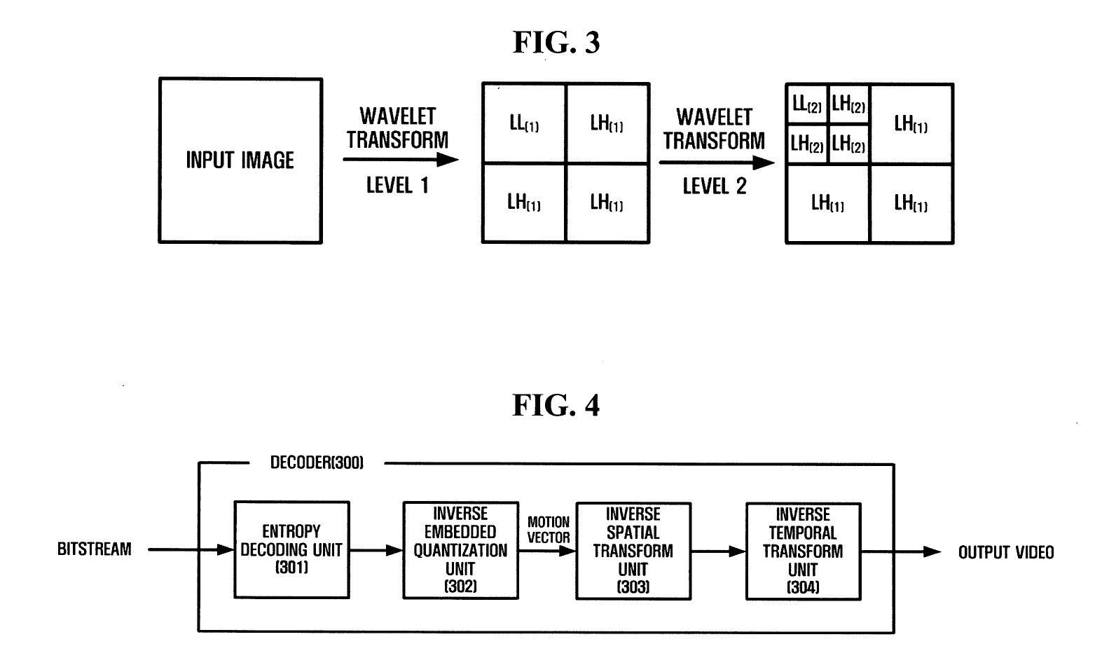

FIG. 3 illustrates an example of a procedure in which the spatial transform unit 104 shown in FIG. 2 decomposes an input image or frame into sub-bands using wavelet transform.

For example, assuming that wavelet transform of an input image or frame is performed in two levels, there are three types of high-frequency sub-bands in horizontal, vertical, and diagonal directions, respectively.

A low-frequency sub-band, i.e., a sub-band having a low frequency in both of the horizontal and vertical directions, is expressed as “LL”.

The three types of high-frequency sub-bands, i.e., a horizontal high-frequency sub-band, a vertical high-frequency sub-band, and a horizontal and vertical high-frequency sub-band, are expressed as “LH”, “HL”, and “HH”, respectively.

The low-frequency sub-band is decomposed again. The numeral in parenthesis associated with the sub-band expressions indicates the wavelet transform level.

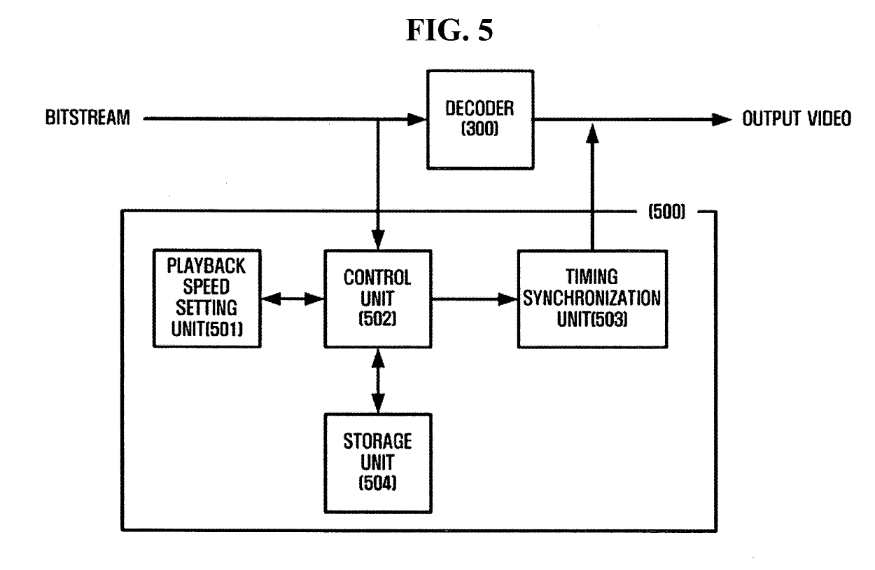

FIG. 4 is a schematic diagram of a decoder 300 according to an embodiment of the present invention.

Operations of the decoder 300 are usually performed in reverse order to those of the encoder 100.

The decoder 300 includes an entropy decoding unit 301, an inverse embedded quantization unit 302, an inverse spatial transform unit 303, and an inverse temporal transform unit 304.

The decoder 300 operates in a substantially reverse direction to the encoder 100.

However, while motion estimation has been performed by the motion estimator 102 of the encoder 100 to determine a motion vector, an inverse motion estimation process is not performed by the decoder 300, since the decoder 300 simply receives the motion vector 102 for use.

The entropy decoding unit 301 decomposes the received bitstream for each wavelet block.

The inverse embedded quantization unit 302 performs an inverse operation to the embedded quantization unit 105 in the encoder 100.

In other words, wavelet coefficients rearranged for each wavelet block are determined from each decomposed bitstream.

The inverse spatial transform unit 303 then transforms the rearranged wavelet coefficients to reconstruct an image in a spatial domain.

In this case, inverse wavelet transformation is applied to transform the wavelet coefficients corresponding to each GOP into temporally filtered frames.

Finally, the inverse temporal transform unit 304 performs inverse temporal filtering using the frames and motion vectors generated by the encoder 100 and creates a final output video.

As described above in the encoder 100, the present invention can be applied to moving videos as well as still images. Similarly to the moving video, the bitstream received from the encoder 100 may be passed through the entropy decoding unit 301, the inverse embedded quantization unit 302, the inverse spatial transform unit 303, and the inverse temporal transform unit 304, and transformed into an output image.

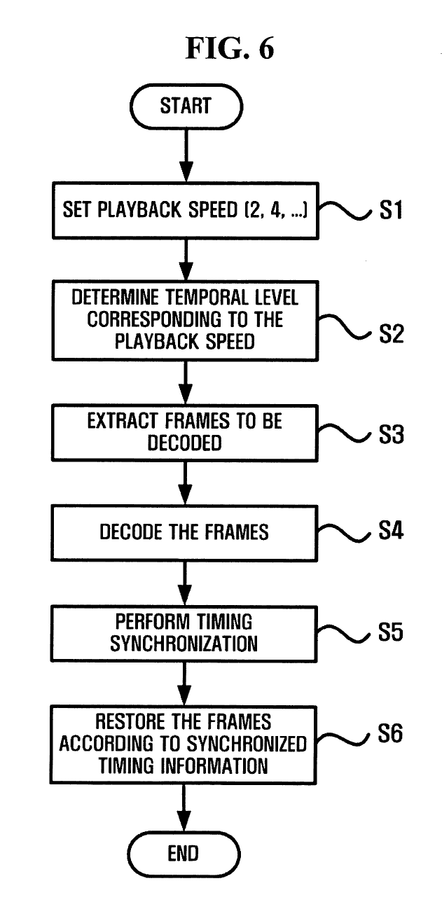

FIG. 5 is a schematic diagram of a video stream reproducing apparatus 500 using the decoder 300 shown in FIG. 4 according to an embodiment of the present invention.

As shown in FIG. 5, the video stream reproducing apparatus 500 includes a playback speed setting unit 501, a control unit 502, a timing synchronization unit 503, and a storage unit 504.

When a fast video search is requested through, for example, a predetermined user interface, the playback speed setting unit 501 sets a playback speed for a bitstream received from the encoder 100.

The control unit 502 determines a temporal level corresponding to the playback speed set by the playback speed setting unit 501 and extracts some frames for partial decoding in the decoder 300 from the received bitstream using the determined temporal level as an extraction condition.

In addition, the control unit 502 generates a timing signal to synchronize the extracted frames with a frame rate of an original video signal, i.e., the bitstream received from the encoder 100, so that the fast video search can be performed at the set playback speed.

The playback speed is a speed at which images of frames in the bitstream are displayed and may be changed to 2×, 4×, and 8× in an embodiment of the present invention for the fast video search.

In addition, the playback speed may be applied to both of reverse playback and forward playback.

Hereinafter, in an embodiment of the present invention, when there are three temporal levels in accordance with temporal scalability of video coding, 8×, 4× and 2× playback speeds are set to temporal levels 3, 2, and 1, respectively.

The timing synchronization unit 503 sets the timing signal received from the control unit 502 for every frame of output video from the decoder 300.

As a result, each of the frames is synchronized with the frame rate of the original video signal received from the encoder 100, and therefore, fast video is provided at the frame rate of the original video signal.

Meanwhile, the storage unit 504 is controlled by the control unit 502 to store the bitstream received from the encoder 100.

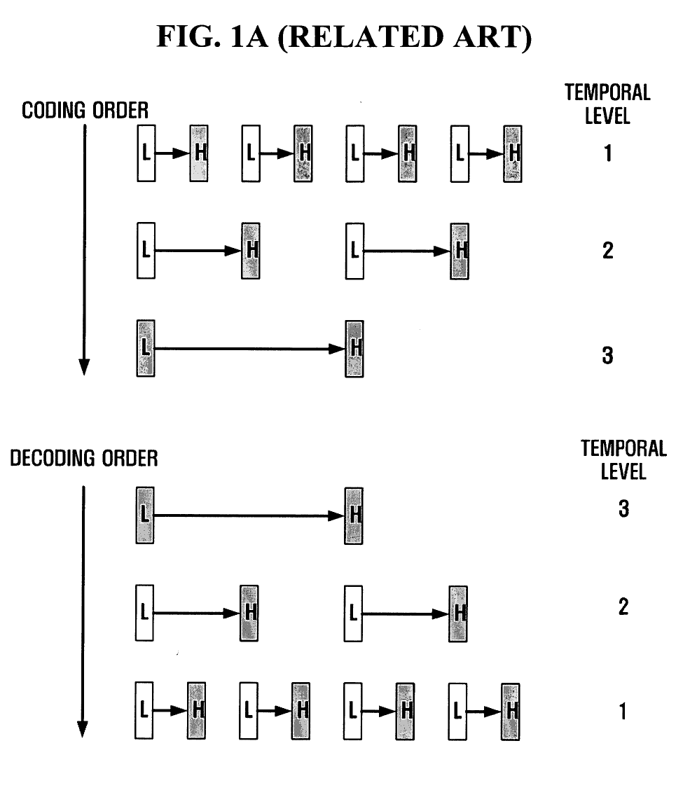

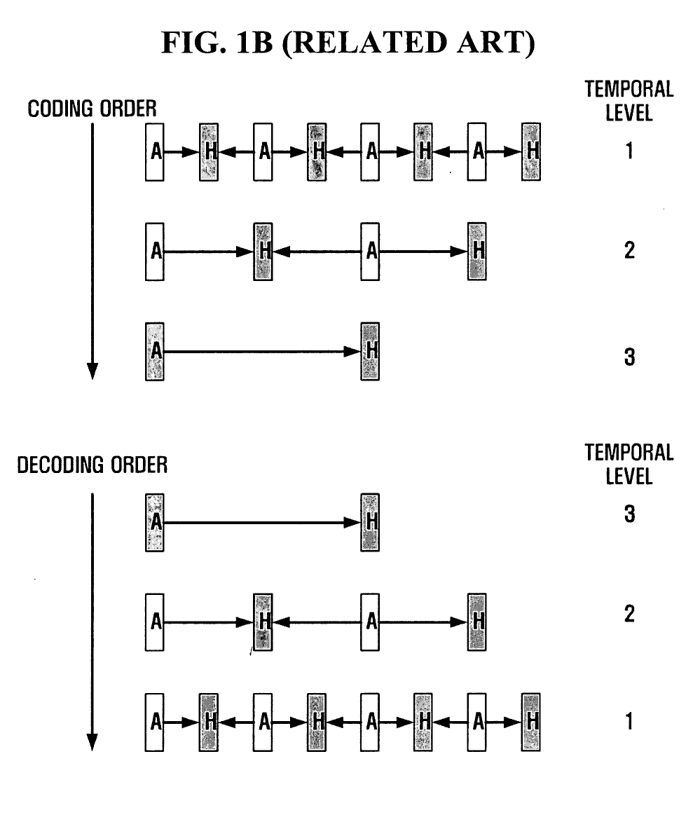

For example, referring to FIGS. 1A and 1B, when 2× forward playback of video is requested, the control unit 502 selects the temporal level 1 corresponding to the 2× playback speed.

Next, the control unit 502 extracts four frames (e.g., a single L-frame and three H-frames), for partial decoding in the decoder 500, from a bitstream of the video according to the selected temporal level 1 and determines the four frames as to be decoded.

Thereafter, the control unit 502 inputs the four frames into the decoder 300 for decoding.

When the four frames are decoded, four L-frames are generated. The control unit 502 generates timing information to synchronize the decoded L-framed with a frame rate of the bitstream received from the encoder 100.

Then, the timing synchronization unit 503 synchronizes the four decoded L-frames with the original signal according to the timing signal from the control unit 502. As a result, video comprised of the four L-frames is reproduced.

Through the above-described operations, the four L-frames extracted from the bitstream received from the encoder 100 according to the temporal level corresponding to the requested playback speed are decoded and reproduced at the frame rate of the original video signal, and therefore, fast video search is performed at a 2× speed.

The video stream reproducing apparatus 500 performs these operations on each group of picture (GOP) in an embodiment of the present invention.

In another embodiment of the present invention, the encoder 100 shown in FIG. 2 may perform spatial transform using the spatial transform unit 104 before performing temporal transform using the temporal transform unit 103.

In this case, the decoder 300 shown in FIG. 4 also changes the decoding order according to the encoding order and thus performs inverse temporal transform before performing inverse spatial transform.

In the encoder 100, the decoder 300, and the video stream reproducing apparatus 500, all modules may be implemented in hardware or some or all of the modules may be implemented in software.

Accordingly, it is obvious that the encoder 100, the decoder 300, and the video stream reproducing apparatus 500 may be implemented in hardware or software and changes or modifications may be made according to hardware and/or software configuration, without departing from the spirit of the invention.

In the embodiment illustrated in FIG. 5, the video stream reproducing apparatus 500 is added to the decoder 300. However, the present invention is not restricted thereto. For example, the video stream reproducing apparatus 500 may be included in the encoder 100 or a separate server providing video streaming service at a remote place.

A method of reproducing video streams using the encoder 100, the decoder 300, and the video stream reproducing apparatus 500, according to an embodiment of the present invention, will now be described in detail with reference to the attached drawings.

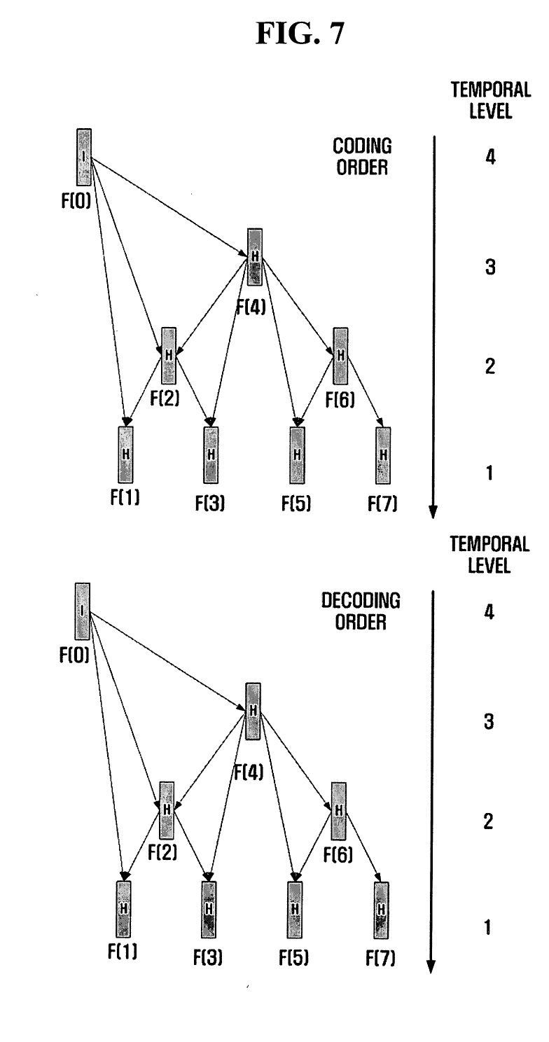

FIG. 6 is a schematic flowchart of a method of reproducing video streams according to an embodiment of the present invention.

As shown in FIG. 6, when a user requests fast search, in operation S1, the playback speed setting unit 501 sets a playback speed for a bitstream received from the encoder 100.

Then, in operation S2, the control unit 502 determines a temporal level corresponding to the playback speed.

Next, in operation S3, the control unit 502 extracts frames to be decoded from the bitstream received from the encoder 100 using the temporal level as an extraction condition.

In operation S4, the control unit 502 inputs the extracted frames into the decoder 300 to decode the frames.

In operation S5, the timing synchronization unit 503 synchronizes the decoded frames with a frame rate of an original video signal, i.e., the bitstream received from the encoder 100 according to a timing signal generated by the control unit 502.

Then, in operation S6, the frames are restored according to synchronized timing information and thereby reproduced at the playback speed requested by the user.

In the above-described embodiments of present invention, an apparatus and method for reproducing scalable video streams use MCTF- and UMCTF-based video coding methods. However, the present invention can also be used for video streams generated by other diverse video coding methods supporting temporal scalability besides the MCTF- and UMCTF-based video coding methods.

For example, to maintain temporal scalability and control delay time, encoding and decoding may be performed using a successive temporal approximation and referencing (STAR) algorithm by which temporal transform is performed in a constrained order of temporal levels, which will be described below.

In the basic conception of the STAR algorithm, all frames at each temporal level are expressed as nodes and a referencing relationship is expressed by an arrow. Only necessary frames can be positioned at each temporal level. For example, only a single frame among frames in a GOP can be positioned at a highest temporal level. In an embodiment of the present invention, a frame F(0) has the highest temporal level. At subsequent lower temporal levels, temporal analysis is successively performed and error frames having a high-frequency component are predicted from original frames having coded frame indexes. When a size of a GOP is 8, the frame F(0) is coded into an I-frame at the highest temporal level. At a subsequent lower temporal level, a frame F(4) is encoded into an interframe, i.e., an H-frame, using the frame F(0). Subsequently, frames F(2) and F(6) are coded into interframes using the frames F(0) and F(4). Lastly, frames F(1), F(3), F(5), and F(7) are coded into interframes using the frames F(0), F(2), F(4), and F(6).

In a decoding order, the frame F(0) is decoded initially. Next, the frame F(4) is decoded referring to the frame F(0). Similarly, the frames F(2) and F(6) are decoded referring to the frames F(0) and F(4). Lastly, the frames F(1), F(3), F(5), and F(7) are decoded referring to the frames F(0), F(2), F(4), and F(6).

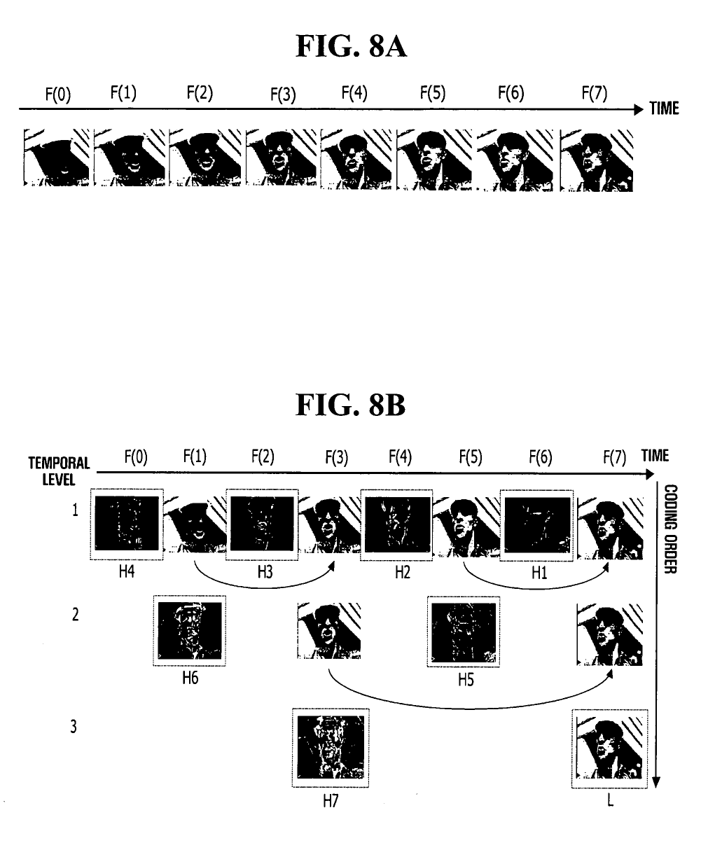

FIG. 7 illustrates encoding and decoding procedures using the STAR algorithm.

Referring to FIG. 7, according to an equation regarding a set Rₖ of reference frames to which a frame F(k) can refer according to the STAR algorithm, it can be inferred that the frame F(k) can refer to many frames.

Due to this characteristic, the STAR algorithm allows many reference frames to be used.

In embodiments of the present invention, connections between frames possible when the size of a GOP is 8 are described.

An arrow starting from a frame and returning back to the frame indicates prediction in an intra mode.

All of the original frames having coded frame index including frames at H-frame positions at the same temporal level can be used as reference frames.

However, in the related art technology, original frames at H-frame positions can refer to only an A-frame or an L-frame among frames at the same temporal level.

For example, the frame F(5) can refer to the frames F(3) and F(1).

Even though the amount of memory used for temporal filtering and processing delay time increase when using multiple reference frames, it is effective to use the multiple reference frames.

Hereinafter, a method of reproducing video streams to make fast video search feasible by changing a playback speed with respect to a scalable video stream having temporal scalability will be described in detail with reference to the attached drawings.

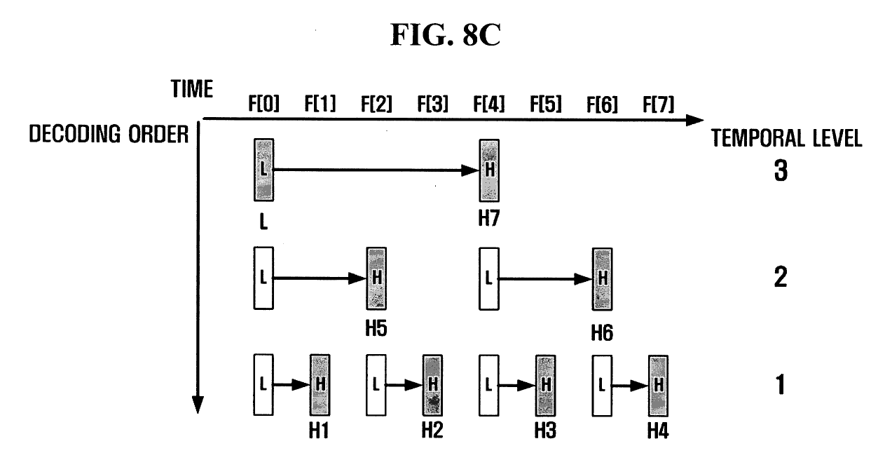

In an embodiment of the present invention, when a video stream including a GOP comprised of 8 frames F(0) through F(7), as shown in FIG. 8A, is encoded using an MCTF encoder, the encoder performs temporal filtering on pairs of frames in an ascending order of temporal levels and thereby transforms frames at a lower temporal level into L-frames and H-frames at a higher temporal level and then transforms pairs of the transformed L-frames into frames at a much higher temporal level, as shown in FIG. 8B.

Thereafter, dark H-frames and a single L-frame at the highest temporal level in FIG. 8B, which are generated through the temporal filtering, are processed by spatial transform. As a result, a bitstream is generated and output.

Then, a user can receive the bitstream output from the encoder and decode it using a decoding procedure corresponding to the encoding procedure to reproduce it and thereby use video streaming service.

When the user of the video streaming service selects a 4× forward playback to search video fast, the playback speed setting unit 501 sets a playback speed for the bitstream received from the encoder to 4× forward in response to the user's request for fast video search.

Next, the control unit 502 determines the temporal level 2 corresponding to the 4× forward playback.

Next, the control unit 502 extracts frames H5, H6, H7, and L to be decoded using the temporal level 2 as an extraction condition (see FIG. 8C).

Next, the control unit 502 decodes the frames H5, H6, H7, and L using a decoder.

As a result of decoding, the frames F(0) and F(4) are generated. Then, the timing synchronization unit 503 synchronizes the decoded frames F(0) and F(4) with a frame rate of an original video signal according to a timing signal generated by the control unit 502 and thereby restores the frames F(0) and F(4) according to synchronized timing information.

In other words, timing information of the decoded frames F(0) and F(4) is changed on a time axis by the timing synchronization unit 503 and thus the frames F(0) and F(1) are restored. As a result, the original video signal comprised of 8 frames is reproduced using the two frames F(0) and F(l), and therefore, it is provided to the user at the 4× forward playback speed.

Alternatively, when the user selects a 2× reverse playback speed to search a video fast, the playback speed setting unit 501 sets playback speed for the bitstream received from the encoder and then stored in the storage unit 504 to 2× reverse in response to the user's request for fast video search.

Next, the control unit 502 determines the temporal level 1 corresponding to the 2× reverse playback.

Next, the control unit 502 reads the bitstream stored in the storage unit 504 and extracts frames H1, H2, H3, H4, H5, H6, H7, and L to be decoded using the temporal level 1 as an extraction condition (see FIG. 8C).

Next, the control unit 502 decodes the frames H1, H2, H3, H4, H5, H6, H7, and L using a decoder.

As a result of decoding, the frames F(0), F(2), F(4), and F(6) are generated. Then, the control unit 502 generates a timing signal to restore frames in a reverse direction.

Then, the timing synchronization unit 503 synchronizes the decoded frames F(0), F(2), F(4), and F(6) with the frame rate of the original video signal in reverse order like F(6), F(4), F(2), and F(0) according to the timing signal generated by the control unit 502.

In other words, timing information of the decoded frames is changed in order of F(0), F(1), F(2), and F(3) and then the decoded frames F(0), F(1), F(2), and F(3) are restored in a backward direction on the time axis. As a result, fast video search can be provided through the 2× reverse playback requested by the user.

For convenience of use and clarity of the description, playback speed is restricted to 4× and 2×. However, it is apparent that the present invention can be used for other speeds.

Generally, since it is possible to decode up to a certain frame in scalable video decoding, it is also possible to decode only a desired number of frames at a desired playback speed. In this situation, a satisfactory result can be obtained by controlling the number of frames to be decoded instead of a temporal level.

According to the present invention, since a fast search mode can be realized without increasing the number of decoded images, power consumption of a decoder can be decreased.

In addition, user friendly streaming service providing the fast search mode without greatly changing the quality of pictures can be provided.

In concluding the detailed description, those skilled in the art will appreciate that many variations and modifications can be made to the exemplary embodiments without substantially departing from the principles of the present invention. Accordingly, the scope of the invention is to be construed in accordance with the following claims.

1. A method of reproducing scalable video streams, comprising:
determining a temporal level corresponding to a playback speed requested for a bitstream;
extracting frames to be decoded from all frames in the bitstream according to the determined temporal level; and
decoding the extracted frames.

2. The method of claim 1, further comprising synchronizing timing of the decoded frames with a frame rate of an original video signal.

3. The method of claim 1, wherein the decoding of the extracted frames comprises:
obtaining transform coefficients by inverse quantizing information regarding the coded frames that are extracted by analyzing the bit stream; and
sequentially performing inverse spatial transform and inverse temporal transform on the transform coefficients.

4. The method of claim 1, wherein the decoding of the extracted frames comprises:
obtaining transform coefficients by inverse quantizing information regarding the coded frames that are extracted by analyzing the bit stream; and
sequentially performing inverse temporal transform and inverse spatial transform on the transform coefficients.

5. The method of claim 1, wherein the bitstream has temporal scalability due to scalable video coding.

6. The method of claim 1, wherein the playback speed is one of a reverse playback speed and a forward playback speed according to a playback direction.

7. The method of claim 1, wherein the playback speed is requested through a user interface.

8. An apparatus for reproducing scalable video streams, comprising:
a playback speed setting unit setting a playback speed;
a control unit determining a temporal level corresponding to the playback speed set by the playback speed setting unit and extracting frames to be decoded from a bitstream according to the determined temporal level; and
a timing synchronization unit synchronizing the frames that are decoded with a frame rate of an original video signal using a timing signal.

9. The apparatus of claim 8, further comprising:
a decoder decoding and restoring the frames extracted by the control unit; and
a storage unit controlled to store the bitstream by the control unit.

10. The apparatus of claim 8, wherein the control unit generates the timing signal used for synchronizing the frames that are decoded with the frame rate of the original video signal.

11. The apparatus of claim 8, wherein the playback speed is selected for a bitstream, and the bitstream has temporal scalability due to scalable video coding.

12. The apparatus of claim 8, wherein the playback speed is one of a reverse playback speed and a forward playback speed according to a playback direction.

13. The apparatus of claim 8, wherein the playback speed is requested through a predetermined user interface.

14. A computer readable medium including a program for reproducing scalable video streams, the program comprising instructions for:
determining a temporal level corresponding to a playback speed requested for a bitstream;
extracting frames to be decoded from all frames in the bitstream according to the determined temporal level; and
decoding the extracted frames.

15. A method of reproducing scalable video streams, comprising:
extracting frames to be decoded from a bitstream according to a playback speed requested for the bitstream;
decoding the extracted frames; and
synchronizing timing of the decoded frames with a frame rate of an original video signal to restore the frames.

16. An apparatus for reproducing scalable video streams, comprising:
a user input unit inputting a playback speed according to a user's request;
a control unit extracting frames to be decoded from the bitstream according to the playback speed;
a decoder decoding the extracted frames; and
a synchronization unit synchronizing the decoded frames with a frame rate of an original video signal.

17. The apparatus of claim 16, further comprising:
a display unit displaying the synchronized frames.
